(19) United States
(12) Patent Application Publication
(10) Pub. No.: US 2019/0012624 A1
(43) Pub. Date: Jan. 10, 2019

(54) METHOD FOR DIGITALLY ACCUMULATING CONSUMER EXPERIENCE

(71) Applicant: L&T Infotech Ltd., Mumbai (IN)

(72) Inventors: Brijesh PRABHAKAR, Bengaluru (IN); Sachin JAIN, Navi Mumbai (IN); Meena MALU, Pune (IN); Karthikeyan BALASUBRAMANIAN, Pune (IN); Deepika VAISHNAVE, Pune (IN)

(21) Appl. No.: 15/810,542

(22) Filed: Nov. 13, 2017

(30) Foreign Application Priority Data
Jul. 8, 2017 (IN) 201721024103

(51) Int. Cl. G06Q 10/06; G06F 9/451

(52) U.S. Cl. CPC G06Q 10/0637; G06F 9/451

(57) ABSTRACT

The present invention generally relates to a real time analytical method and particularly relates to a method for digitally accumulating a consumer experience and analyse the collected data to provide a plurality of suggestion for improving a consumer experience on a target software. The present method allows a consumer oriented data acquisition and analytics in a short time span thus easing a client to optimize their digital platform and enhance the consumer experience. The present invention analyses a plurality of major parameters such as discoverability, accessibility, performance, omni-channel and perception and a plurality of minor parameters for providing analytics.

### BACKGROUND

### Technical Field of Invention

The embodiments of the present invention generally relate to a real time analytical method and particularly relate to a method for digitally accumulating a consumer experience and analyse the collected data to provide a plurality of suggestion for improving a consumer experience on a target software.

### Description of Related Art

Digital platform is an online data sourcing, processing and delivery process which encapsulates a plurality of various ways of communicating with the end-user of the software application. This application can be static website, dynamic website, e-commerce platform, job portal, mobile applications, desktop based application, CRM/ERP applications like SAP, etc. These digital platforms cater various necessities of a user and experience on each of them differs due to various factors. In a past decade there has been a huge development over enhancing a user experience by providing a simplistic approach while developing digital software. Also, the speed of a process flow in a software application has enhanced.

However, still there are many parameters which reduces consumer or end user experience. These parameters are vivid in natures and difficult to track and solve simultaneously. Also, due to lack of an automated mechanism of analysing a consumer experience on the basis of these parameters, there has been insignificant upgradation in consumers over the considered parameters. Lastly the mechanisms are all reactive and there are no proactive mechanisms.

In the view of foregoing, there is a need for an efficient real time method for a collecting a plurality of data pertaining to consumer experience over a digital platform and a computer readable codes or software application. Also, there is a need for an online method to accumulate a data pertaining to a consumer experience, analyse the data, deriving a root cause of the consumer experience and providing one or more suggestion to enhance the same over a targeted application.

The above-mentioned shortcomings, disadvantages and problems are addressed herein, as detailed below.

### OBJECTS OF THE INVENTION

The primary object of the embodiments herein is to provide an efficient real time method for a collecting a plurality of data pertaining to consumer experience over a digital platform and a computer readable codes or software application.

Yet another object of the present invention is to provide a real time method to accumulate a data pertaining to a consumer experience, analyse the data, deriving a root cause of the consumer experience and providing one or more suggestion to enhance the same over a targeted software application.

These and other objects and advantages of the embodiments herein will become readily apparent from the following detailed description taken in conjunction with the accompanying drawings.

### SUMMARY OF THE INVENTION

The various embodiments of the present invention provide a method of accumulating a consumer experience related data over a targeted digital platform. The method comprises the steps of:
a) integrating a computer readable code with a target digital platform for collecting data pertaining to the digital platform. The collected data comprises a working of the digital platform.
b) categorizing the working of the digital platform and a consumer reaction towards the digital platform into a plurality of primary parameters.
c) sub-categorizing the plurality of primary parameters into a plurality of secondary parameters. Each secondary parameter represents a working aspect of the corresponding primary parameter.
d) accumulating a data for digital platform function and consumer behaviour against the secondary parameters.

According to one embodiment of the present invention, the computer readable code observes the primary and secondary parameters during a run time usage of a target digital platform by a user. The computer readable code maps the accumulated data against the secondary parameters with the parameters of an optimally running digital platform taken as reference.

According to one embodiment of the present invention, the computer readable code autocorrects the secondary parameters to attain the parameters of the optimally digital platform taken as reference.

According to one embodiment of the present invention, the computer readable code provides specific suggestion on the basis of analysis of the secondary parameters for improving a function of digital platform and a consumer experience.

According to one embodiment of the present invention, the primary parameters comprise discoverability, accessibility, performance, omni-channel and perception.

According to one embodiment of the present invention, the secondary parameters under discoverability comprise visitors (Alexa™ ranking, traffic estimation, content delivery network), mobility (viewport, heavy images, mobile rendering, mobile HTTP headers, browser caching, auto refresh, character encoding support, image map, images specify size, link target format, measures, embedded objects or scripts, pop ups, provide defaults, table alternatives), Search Engine Optimization (title, meta description, URL rewrite, sitemapXML, robots.txt, image-alt check, Google preview, query URL, broken links, underscore links, header tags, image-alt check, meta tags, Google analytics, keyword consistency, domain first registered, domain expire date, blogs, in-page links, back links, related websites), technology (doctype, image file format, encoding, web server, name server, server IP, site elements), usability (URL, language, favicon, media print test, inline CSS, custom 404 page, conversion forms, microformats, Dublin core, SSL certificate, page size, load time), security (plain text email, IP canonicalization, URL canonicalization, IPV6 compatibility), social share-ability (social media check, social media activity), and speed optimization (flash, frames, iframes, CSS minification, nested table, HTML page size, Gzip test, markup validator, CSS validator, JS minification). Further the said method assesses an authentication application during a navigation from one page to another over a digital platform.

According to one embodiment of the present invention, the secondary parameter under accessibility comprises an ease of navigation through the digital platform, perceivable (text alternative, time based media, adaptable), operable (keyboard accessible, enough time, seizures, navigable), understandable (readable, predictable, input assistance), and robust (compatible).

According to one embodiment of the present invention, the secondary parameters under performance comprise minification, response time, page size, stability, investigate, measure and validate or verify other quality attributes.

According to one embodiment of the present invention, the secondary parameters under omni-channel comprise windows layout (GUI compatibility across devices and browsers on windows OS), MAC layout (GUI compatibility across devices and browsers on MAC OS), workflow (Functional testing of web application on different desktop devices), device flow (functional testing of web application on different mobile devices), orientation (each time the device is rotated, the web page has to be rendered again), redirect & link (simulators driven by a mouse often have more precision that real fingers do), and touch & scroll.

According to one embodiment of the present invention, the secondary parameters under perception comprise thinking, patience and visual appeal.

According to one embodiment of the present invention, the primary and secondary parameters are relative in nature. A value of the secondary parameters is calculated on a basis of a reference parameter obtained from a near-perfect digital platform.

According to one embodiment of the present invention, the primary and secondary parameters are absolute in nature. A value of the secondary parameters is calculated on a basis of an estimated maximum value of considered parameter. The estimated maximum value is provided through a mathematical based formula.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart for a method of accumulating and analysing a consumer experience over a digital platform, according to one embodiment herein.

FIG. 2 illustrates an exemplary user interface with details of analysis drawn on the basis of analysing consumer experience over a set of parameters, according to one embodiment herein.

FIG. 3 illustrates an exemplary data acquired from a consumer while visiting a targeted digital platform to derive a consumer perception, according to one embodiment herein.

FIG. 4 illustrates an exemplary report for the primary parameter “discoverability”, according to one embodiment of the present invention.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

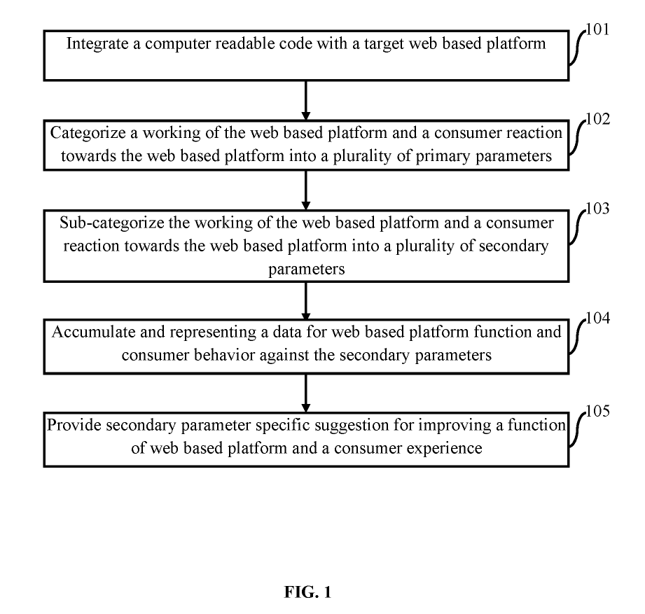

FIG. 1 illustrates a flowchart for a method of accumulating and analysing a consumer experience over a digital platform, according to one embodiment herein. With respect to FIG. 1, the method comprises the steps of:
a) integrating a computer readable code with a target digital platform (101);
b) categorizing a working of the digital platform and a consumer reaction towards the digital platform into a plurality of primary parameters (102);
c) sub-categorizing the working of the digital platform and a consumer reaction towards the digital platform into a plurality of secondary parameters (103);
d) accumulating and representing a data for digital platform function and consumer behaviour against the secondary parameters (104);
e) providing secondary parameter specific suggestion for improving a function of digital platform and a consumer experience (105).

According to one embodiment herein, the primary parameters comprise discoverability, accessibility, performance, omni-channel and perception.

According to one embodiment herein, the secondary parameters under discoverability comprise Alexa™ ranking, query URL, broken links, underscore links, responsiveness.

According to one embodiment herein, the secondary parameter under accessibility comprises an ease of navigation through the digital platform and Text Alternative.

According to one embodiment herein, the secondary parameters under performance comprise minification, response time and page size.

According to one embodiment herein, the secondary parameters under omni-channel comprise windows layout, MAC layout, workflow, device flow, orientation, redirect & link and touch & scroll.

According to one embodiment herein, the secondary parameters under perception comprise thinking, patience and visual appeal.

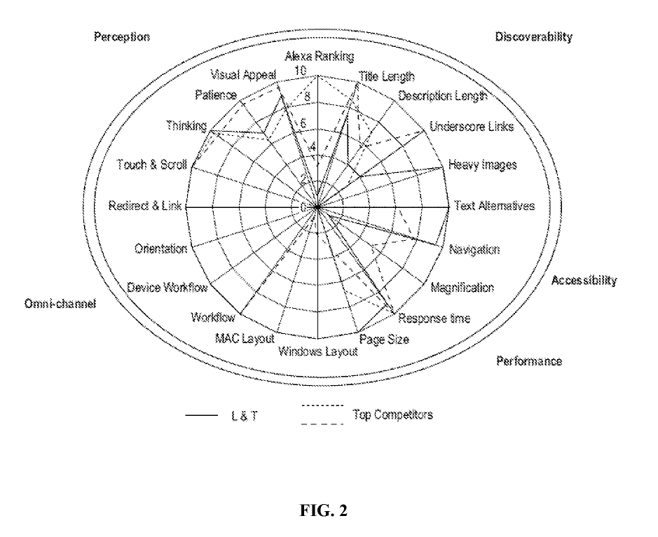

FIG. 2 illustrates an exemplary user interface with details of analysis drawn on the basis of analysing consumer experience over a set of parameters, according to one embodiment herein. With respect to FIG. 2, the value of the primary and the secondary parameters are displayed in a user understandable format such as a numeral range or a percentage.

According to one embodiment herein, the primary and secondary parameters can be relative in nature. A value of the secondary parameters is calculated on a basis of a reference parameter obtained from a near-perfect digital platform.

According to one embodiment herein, the primary and secondary parameters can be absolute in nature. A value of the secondary parameters is calculated on a basis of an estimated maximum value of considered parameter. The estimated maximum value is provided through a mathematical based formula.

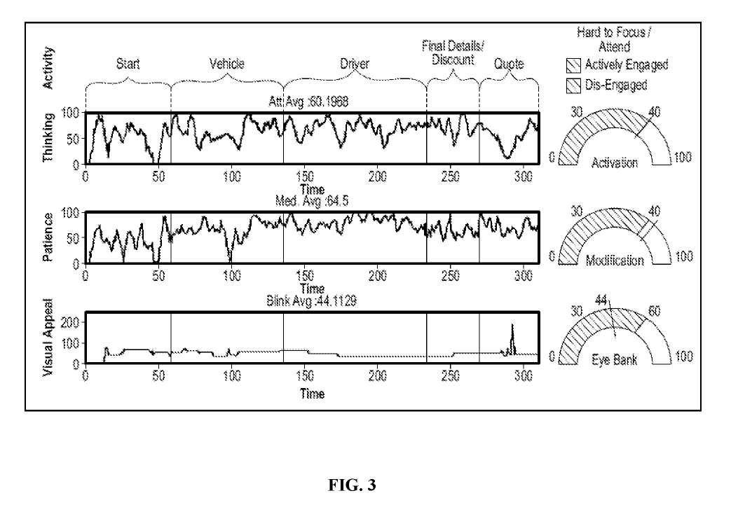

FIG. 3 illustrates an exemplary data acquired from a consumer while visiting a targeted digital platform to derive a consumer perception, according to one embodiment herein. With respect to FIG. 3, the consumer behaviour is accessed through a wearable device to assess a real-time reaction of the consumer while visiting the targeted website. The primary parameter “perception” is assessed by analysing a brainwave of a customer in which an analysis of an alpha and a beta wave provides a thinking parameter, and an analysis of a delta and a theta wave provides patience. With a dip in a potential drop in any wave, an analysis on a visual appeal of the customer is drawn. The values are estimated by implementing a mathematical formulae or human interpretation of the graphical output obtained from the wearable device. Then, a customer activity is mapped with respect to the brainwaves in terms of seconds and score is provided for a behavior of customer for each activity like button & link clicks, form entry, navigation etc. So, an analysis of the overall customer experience is done and broken down to page level, and even to field and buttons. Using the said analysis, various conclusions are made such as the page drops with assists in highlighting an activity with poor or excitement region of perception parameter and are considered as critical activities. These critical activities are then further analyzed for the reason of happening and suggestions are given by the digital architects for a change in activity flow to bring the brainwaves to the comfort zone. Once the brainwaves are in comfort zone which denotes the application is usable, makes the customer to likes the application and also helps to reduce the retention rate. This further helps in implementing an A/B testing methodology where a comparison is drawn between an experience of two variants of page and choose the best one for a better digital customer experience.

According to one embodiment herein, a report with suggestive remarks is generated automatically by the computer readable code after analysing the primary and secondary parameters.

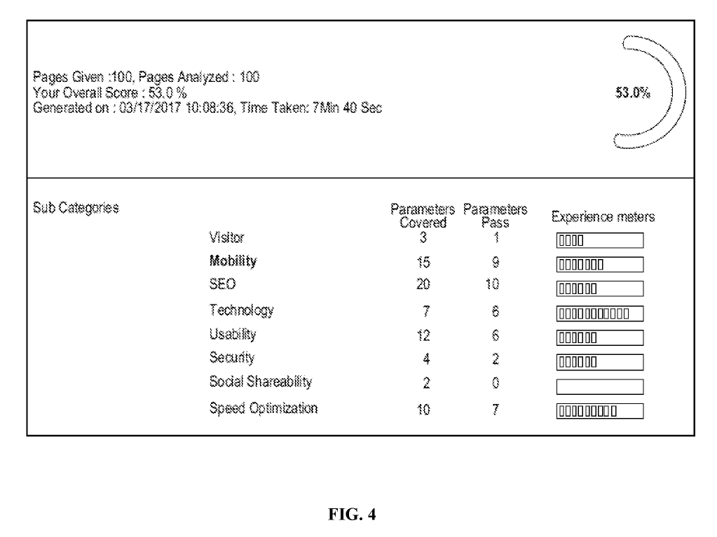

FIG. 4 illustrates an exemplary report for the primary parameter “discoverability”, according to one embodiment of the present invention.

Discoverability—Visitors:

Alexa Traffic Rank—

Alexa's traffic estimates and ranks are based on the browsing behavior of people in our global data panel which is a sample of all internet users. The site with the highest combination of visitors and pageviews over the past 3 months is ranked #1. The site with the least is ranked somewhere around 30 million. (PASS: <10000 and 10000<WARN<300000)
Sample—Alexa's Traffic Rank
Global Rank: 59916 India Rank: 5357

Traffic Estimation—

No. of users hitting the targeted Website. (Note: All traffic values are estimates only.)
Sample—Visitors Traffic Details:
Daily Unique Visitors: 25,099, Monthly Unique Visitors: 763,934, Yearly Unique Visitors: 9,161,135

Content Delivery Network (CDN)—

A content delivery network or content distribution network (CDN) is a globally distributed network of proxy servers deployed in multiple data centers. The goal of a CDN is to serve content to end-users with high availability and high performance.

The site https://www.abcdef.com is not using a CDN to serve its static assets (images, stylesheets, scripts, . . . ).

| COUNT | HOST | CDN |
|---|---|---|
| 1 | az416426.vo.msecnd.net | Windows Azure |
| 1 | code.jquery.com | — |
| 2 | connect.facebook.net | — |
| 1 | d31qbvlcthcecs.cloudfront.net | Amazon Cloudfront |
| 1 | d5nxst8fruw4z.cloudfront.net | Amazon Cloudfront |
| 1 | dbsugv5o22gme.cloudfront.net | Amazon Cloudfront |
| 1 | dc.services.visualstudio.com | — |
| 1 | googleads.g.doubleclick.net | Google |
| 1 | img07.en25.com | Akamai |
| 2 | s1202999527.t.eloqua.com | — |
| 1 | snan.licdn.com | Akamai |
| 1 | stats.g.doubleclick.net | Google |
| 1 | www.facebookcom | — |

Discoverability—Mobility:

Viewport—

The viewport is the section of the page in view. An example is viewing a web page on a mobile device, if it is zoomed in to display the top left of the page then the viewport has been set to be a certain width.
Sample—Meta Viewport Tag is present.
initial-scale=1.0, width=device-width

Heavy Images—

Image size more than 250 KB are not good for mobile devices. It slow downs the speed of operations on the handset. So it is recommended to keep the image size less than 250 KB.
Sample—Congrats! You are not using images greater than 250 KB in size

Mobile Rendering—

Website should render properly on different sized devices, that means mobile users will not need to zoom-in and out or scroll left and right to view content of your pages from their phone. It also means that editors of website content only need to enter information in one place, and it is made available instantly on the web and on smartphones.
Sample—Snapshots of Mobile rendered website

Mobile HTTP Headers—

HTTP header fields are components of the header section of request and response messages in the Hypertext Transfer Protocol (HTTP).
Sample—Response headers received by Googlebot mobile

| Header Name | Header Value |
|---|---|
| Cache-Control | no-cache, no-store |
| Content-Type | text/html; charset=urf-8 |
| Date | Fri, 17 Mar 2017 04:32:00 GMT |
| Expires | −1 |
| Micro- | Service |
| softSharePointTeamService | |
| Micro- | 15.0.0.4745 |
| softSharePointTeamServices | |
| Pragma | no-cache |
| request-id | 63cbde9d-4270-80d5-f1b7-06233f700fbc |
| Server | Microsoft-IIS/8.0 |
| Set-Cookie | ; HttpOnly; Secure |
| SPIisLatency | 0 |
| SPRequestDuration | 156 |
| SPRequestGuid | 63cbde9d-4270-80d5-f1b7-06233f700fbc |
| Vary | Accept-Encoding |

Browser Caching—

Leverage browser caching: Website performance on Mobile depends on Browser Caching. Browsers cache a lot of information (stylesheets, images, JavaScript files, and more) so that when a visitor comes back to your site, the browser doesn't have to reload the entire page. It is recommended to keep minimum cache time of one week and preferably up to one year for static assets, or assets that change infrequently. Setting an expiry date or a maximum age in the HTTP headers for static resources instructs the browser to load previously downloaded resources from local disk rather than over the network.
Sample—Cache control appears to be disabled.

| Header Name | Header Value |
|---|---|
| Cache-Control | no-cache, no-store |
| | No-cache: It shows that returned responses can [symbol] be used for subsequent |
| | requests to the same URL before checking if server responses have changed. |
| | No-Store: It disallows browsers and all intermediate caches from storing any |
| | versions of returned responses i.e. responses containing private/personal information |
| | or banking data. Every time users request this asset, requests are sent to the server. |
| | The assets are downloaded every time. |
| Expires | −1 |
| | Expires is simply a basic date-time stamp. It [symbol] fairly useful for old user |
| | agents which still roam unchartered territories. It is however important to note that |
| | cache-control headers, max-age and s-maxage still take precedence on most modern |
| | systems, It [symbol] however good practice to set matching values here for the |
| | sake of compatibility. It [symbol] also important to ensure you format the date |
| | properly or it might be considered as expired. To avoid breaking the specification, |
| | avoid setting the date value to more than a year. |

[symbol]

indicates data missing or illegible when filed

Auto Refresh—

Auto-refreshing pages are widely recognized as presenting accessibility problems. In a mobile environment, they may expose the user to undue cost as a result of such a page being left open or put unnoticed into the background. If an auto refreshing page is demanded by the application, always provide a means of ceasing the refresh and always inform the user that the page will refresh and may expose them to higher usage costs. Do not create periodically auto-refreshing pages, unless you have informed the user and provided a means of stopping it.
Sample—Great! Pages are not auto-refreshing periodically.

Character Encoding Support—

Ensure that content is encoded using a character encoding that is known to be supported by the device.
Sample—Content should not be sent to a device if it cannot use it.
[symbol] The resource http://www.lntinfotech.com/Style%20Library/LNT_Infotech_Site/CSS/Landing-News.css uses HTTPS and the certificate is invalid
[symbol] The resource http://www.lntinfotech/com/Style%20Library/LNT_Infotech_Site/CSS/common-css.css uses HTTPS and the certificate is invalid
[symbol] The resource http://www.lntinfotech.com/Style%20Library/LNT_Infotech_Site/CSS/media-query-Landing.css uses HTTPS and the certificate is invalid
[symbol] The resource http://www.lntinfotech.com/Style%20Library/LNT_Infotech_Site/CSS/settings.css uses HTTPS and the certificate is invalid
[symbol] The resource http://www.lntinfotech.com/Style%20Library/LNT_Infotech_Site/CSS/style-landing.css uses HTTPS and the certificate is invalid
[symbol] The resource http://www.lntinfotech.com/Style%20Library/LNT_Infotech_Site/CSS/top-footer-css-landing.css uses HTTPS and the certificate is invalid
[symbol] The resource http://www.lntinfotech.com/_layouts/15/1033/styles/Themable/corev15.css?rev=OqAycrayMLoQIDkAlzHdMhQ%3D%3D uses HTTPS and the certificate is invalid

Image Maps—

Image maps allow fast navigation providing the requesting device can support the image involved and providing there is a means of navigating the map satisfactorily. Up, down, left, right and enter are available on most mobile devices, even if there is no pointing device. This is usually sufficient to allow navigation of the active regions of client-side image maps where they are defined as geometric shapes. Many mobile devices lack a pointing device and server-side image maps cannot be used on such devices. Do not use image maps unless you know the device supports them effectively.
Sample—Not using Image Maps.

Images Specify Size—

Images such as bitmaps have an intrinsic size. Telling the browser in advance what the size is avoids it having to re-flow the page when it receives it. Resizing images at the server reduces the amount of data transferred and the amount of processing the device has to carry out to scale the image. Specify the size of images in markup, if they have an intrinsic size.
Sample—Specify the size of images in markup, if they have an intrinsic size.
[symbol] The resource http://www.facebook.com/tr?id=138601703312705&ev=PageView&noscript=1 uses HTTPS and the certificate is invalid
[symbol] The resource http://d5nxst8fruw4z.cloudfront.net/atrk.gif?account=sgN1o1QolK10O7 uses HTTPS and the certificate is invalid
[symbol] Either the height or width attribute is missing

Link Target Format—

Links to content that is in a different format or different language to that of the page the link is on (i.e. content that can only be interpreted by other applications or downloads) should be human signposted, so that users are not lead to download content that their device may not be able to use. However, bear in mind that some devices support the rendering of those formats by other applications once downloaded (e.g. music files). Additionally, users may wish to download content for later transfer to other devices altogether. So even if it is known that the user agent does not support a particular content type, that content should still be made available. Note the target file's format unless you know the device supports it.
Sample—You are not using clear, concise, descriptive link text to help users decide whether to follow a link.
[symbol] The linked resource https://www.linkedin.com/company/l&t-infotech is served with a character encoding (“”) that may not be appropriate for a mobile device
[symbol] The resource https://www.youtube.com/user/LarsenToubroInfotech uses HTTPS and the certificate is invalid
[symbol] The resource https://twitter.com/LT_Infotech uses HTTPS and the certificate is invalid
[symbol] The resource https://www.facebook.com/LarsenToubroInfotech uses HTTPS and the certificate is invalid
[symbol] The HTTP status code is 404 or 5xx (in response to the resource http://www.linkedin.com/company/l&t-infotech) and the response relates to a request for a linked resource
[symbol] The resource https://www.lntinfotech.com/Blogs/Pages/Blogs.aspx uses HTTPS and the certificate is invalid
[symbol] The resource https://www.lntinfotech.com/Case%20Studies/CS_%20Rice_Optimized%20service%20delivery%20for%20US%20based%20Hi%20Tech%20manufacturer%20by%20developing%20mobile%20application.pdf uses HTTPS and the certificate is invalid
[symbol] The resource https://www.lntinfotech.com/Case%20Studies/CS_BFS_Enabled%20secure%20and%20seamless%20transactions%20between%20client%20stakeholders%20through%20Automated%20business%20processes.pdf uses HTTPS and the certificate is invalid
[symbol] The resource https://www.lntinfotech.com/Case%20Studies/CS_Insurance_Increased%20productivity%20for%20a%20Denmark-based%20Life%20Insurer%20through%20an%20upgraded%20Customer%20contract%20management%20system.pdf uses HTTPS and the certificate is invalid
[symbol] The resource https://www.lntinfotech.com/Contact/ uses HTTPS and the certificate is invalid

Measures—

Avoiding pixel and absolute measures allows the browser to adapt content to fit the display. An exception to rule is where an image has been specifically sized for a particular display. In this case references to the image in markup may specify the exact dimensions of the image in pixels, in order to help the browser to flow the page and avoid re-flowing it after the page has been retrieved. Devices may realize the intentions of authors more accurately if margins, borders and padding are specified in pixels. Do not use pixel measures and do not use absolute units in markup language attribute values and style sheet property values.
Sample—Use percentage and relative measures such as em, ex, bolder, larger and thick.
   [symbol] A length property uses an absolute unit

Embedded Objects or Script—

Many mobile devices do not support embedded objects or script and in many cases it is not possible for users to load plug-ins to add support. Content must be designed with this in mind. Do not rely on embedded objects or script. THIS INCREASES POWER CONSUMPTION AND SO DECREASES BATTERY LIFE.
Sample—You are using embedded objects or script. It'll lead to power consumption!!
   [symbol] The doctunent us setipting.
   [symbol] A “javascript:” link is used
   [symbol] An element uses an event attribute

Pop Ups—

Do not cause pop-ups or other windows to appear and do not change the current window without informing the user. Link targets of _self, _parent or _top should be avoided as only desktop fully supports the tabbed browsing experience.
Sample—Pop-up windows are not supported on many mobile devices, and using them can have unpredicatable results.
   [symbol] A pop-up was detected

Provide Defaults—

Given the typical input limitations of a mobile device, the interface must as far as possible minimize user input. Where possible, use selection lists, radio buttons and other controls that do not require typing. Some markup languages allow the specification of an input mode, which is particularly useful in cases where user input is to be restricted, for example to numeric only. PROVIDE PRE-SELECTED DEFAULT VALUES WHERE POSSIBLE.
Sample—Great! There is a pre-selected value in controls

Tables Alternatives—

Tables do not work well on limited size screens and may result in the user having to scroll horizontally to read them.

Putting navigational links into tables may result in the user having both to scroll horizontally and vertically to see possible navigational choices. WHERE POSSIBLE, USE AN ALTERNATIVE TO TABLULAR PRESENTATION.
Sample—No Additional Info.!!

Discoverability—SEO:

Title—

The title tag is required in all HTML documents and it defines the title of the document. This tag displays the page title in browsers toolbar and in the search-engine results (SERPs). It also provides a title for the page when it is added to favorites. A descriptive <title> tag is important in helping search engines determine your web page's relevancy for certain keywords. Search Engine typically displays the first 50-60 characters of a title tag, or as many characters as will fit into a 512-pixel display. If you keep your titles under 55 characters, you can expect at least 95% of your titles to display properly.
Sample—Length of the Title: 70
ABC Enterprises—Enterprise IT Solutions, Technology, Digital Consulting

Meta Description—

The meta description tag is meant to be a short and accurate summary of your page content. This description can affect your search engine rankings and can also show up directly in search engine results (and affect whether or not the user clicks through to your site). Length of the Description must be in between 70 to 155.
Sample—Length of the Description: 181
ABC Infotech is a Global Enterprise IT Solutions and Digital Services provider, solving complex business and technology challenges at the convergence of digital and physical worlds.

URL Rewrite—

Clean (user-friendly) URLs are the URLs which do not contain query strings. Clean URLs are not only SEO-friendly but are also important for usability.
Sample—Your URLs are not clean! Please refer ‘QueryString URL’ Property down the page

SiteMapXml—

A site map is an XML file that contains list of pages of a web site accessible to crawlers or users.Your website mustcontain one of the ‘sitemap’ file: sitemap.xml, sitemap.xml.gz or sitemapindex.xml.
Sample—SiteMap URL of your site:
https://www.abcinfotech.com/sitemap.xml

Robots.txt—

The robots.txt file is used to provide instructions (like which part to access & which not) about the web site to web robots and spiders. One must contain this simple text files that is placed on the root folder of your website:
Sample—www.yourwebsite.com/robots.txt.

Broken Links—

A broken link or dead link is a link on a web page that no longer works. A good practice is to keep the links to a reasonable number (under 100).
Sample—No. of Broken Links: 1
https://www.abcinfotech.com/pagead/viewthroughconversion/870366145?guid=ON&script=0

Underscore Links=

The general advise is to use hyphens or dashes (-) rather than underscores (_). Google treats hyphens as separators between words in a URL unlike underscores.
Sample—No. of Underscore Links: 21

Header Tags—

Heading tags are part of the HTML coding for a Web page. Headings are defined with H1 to H6 tags. The H1 tag defines the most important heading on the page (usually the largest or boldest, too), whereas H6 indicates the lowest-level heading. H1 tag must be present to pass this criteria.
Sample—H1-5, H2-5, H3-0, H4-6, H5-0, H6-0

H1

- A Leader in NelsonHall NEAT 2017
- LTI a Leader in Forrester WaveTM
- LTI amongst Top 5 service providers
- LTI awarded multi-year contract by HSB
- LTI's IoT Strategy - Help Improve Manufacturing Clients' Operating Performance

H2

- - ARC Advisory's Ralph Rio in Conversation with LTI's Rohit Kedia
- Automation Technologies & Industry Best practices to provide cost savings of up to 55%
- For RPA and AI in Banking
- The Forrester WaveTM : Application Outsourcing Capabilities of Midsize Offshore Vendors, Q4 2016
- for being rated highest by enterprises for “Overall Experience”: Everest Group

H3

- No H3 Tag

H4

- About Us
- Client Speak
- Digital
- Industries
- Services
- Solutions

H5

- No H5 Tag

H6

- No H6 Tag

QueryString URLS—

In a URL (Uniform Resource Locator), the querystring follows a separating character, usually a question mark (?). Your Urls must not contain QueryString so as to make them SEO friendly.
Sample—No. of QueryString Urls: 1

Image-Alt Check—

If an image cannot be displayed (wrong src, slow connection, etc), the alt attribute provides alternative information. So anytime you want to insert image on your page, do not forget to write ‘alt’ attribute corresponding to image.
Sample—Image Alt Count for each URL

Meta Tags—

The meta tag provides metadata about the HTML document. Metadata will not be displayed on the page, but will be machine parsable. Meta data must contain ‘Title’, ‘Description’ & Keywords.

| Meta Tag | Length | Value |
|---|---|---|
| title | 70 | L&T Infotech - Enterprise IT Solutions, Technology, Digital Consulting |
| description | 181 | L&T Infotech is a Global Enterprise IT Solutions and Digital Services provider, solving |
| | | complex business and technology challenges at the convergence of digital and physical |
| | | worlds. |
| keywords | 8 | IT Services, Business Technology Consulting, System Integration, IoT, Digital, Enterprise |
| | | Systems, Mobility, Analytics |
| GENERATOR | | Microsoft SharePoint |
| google-site-verification | | UhC-PiDtE634TLzZ-wh2wp3-L-diq5iBtUpMWyN5Wlk |
| msvalidate.01 | | A4AB7F5A1AB8C83D150261DFC01A24BC |
| viewport | | inital-scale=1.0, width=device-width |
| card | | summary |
| url | | https://www.lntinfotech.com/ |
| image | | https:///wvw.lntinfotech.com/Style%20Library/LNT%20Logos/LNT%20Infotech_jpeg.jpg |
| dcterms.title | | Enterprise IT Solutions, Technology Consulting & Digital Services Provider - L&T |
| | | Infotech |
| dcterms.description | | L&T Infotech is a Global Enterprise IT Solutions and Digital Services provider, solving |
| | | complex business and technology challenges at the convergence of digital and physical |
| | | worlds. |
| dcterms.type | | Text |
| dcterms.identifier | | https://www.lntinfotech.com/ |
| dcterms.format | | text/html |

Google Analytics—

Google Analytics is a freemium web analytics service offered by Google that tracks and reports website traffic. When you create an account in Google Analytics, the account is provided with a unique ID. This ID is part of the tracking code that is inserted in the source code for your site or app.
Sample—<script language=“javascript” type=“text/javascript”>//<![CDATA[(function(i,s,o,g,r,a,m)b{i[‘GoogleAnalyticsObject’]=r;i[r]=i[r]∥function( ){(i[r].q=i[r].q∥[]).push(arguments)}[r].1=1*new Date( );a=s.createElement(o),m=s.getElementsByTagName(o)[0];a.async=1;a.src=g;m.parentNode.insertBefore(a,m)})(window,document,‘script’,‘// www.google-analytics.com/analytics.js’,‘ga’); ga(‘create’, ‘UA-68217349-1’, ‘auto’); ga(‘send’, ‘pageview’); //]]></script>

Keyword Consistency—

It is necesary to use keywords if it is mentioned in metatags.
Sample—No. of Keywords: 8

| | Fre- | | Descrip- | Header |
|---|---|---|---|---|
| Keyword | quency | Title | tion | Tag |
| it services | 0 | [symbol] | [symbol] | [symbol] |
| business technology | 0 | [symbol] | [symbol] | [symbol] |
| consulting | | | | |
| system integration | 1 | [symbol] | [symbol] | [symbol] |
| iot | 2 | [symbol] | [symbol] | [symbol] |
| digital | 8 | [symbol] | [symbol] | [symbol] |
| enterprise systems | 0 | [symbol] | [symbol] | [symbol] |
| mobility | 1 | [symbol] | [symbol] | [symbol] |
| analytics | 1 | [symbol] | [symbol] | [symbol] |

Google Preview—

Displaying snap of website Title & Description, how it looks like with Google search result.
Sample—A Google Preview snapshot

Domain First Registered—

Domain age matters to a certain extent and newer domains generally struggle to get indexed and rank high in search results for their first few months.
Sample—Domain First Registered 15 year(s) 9 month(s) 30 day(s) ago
Wed May 30 00:00:00 IST 2001

Domain Expire Date—

You can register your domain for up to 10 years. By doing so, you will show the world that you are serious about your business.
Sample—Domain will expire 0 year(s) 2 month(s) 13 day(s) from now
Tue May 30 00:00:00 IST 2017

Blog—

A regularly updated website or web page, typically one run by an individual or small group, that is written in an informal or conversational style. Starting a blog is a great way to boost your SEO and attract qualified visitors.
Sample—ABCINFOTECH Blog URL:
https://www.abcinfotech.com/blogs/pages/blogs.aspx

In-Page Links—

In-page Links are the links within the page. Number of links present on each page should be less than or equal to 200.
Sample—Limit the number of links to 200 per page. Use Nofollow!!

BackLinks—

Backlinks are links that point to your website from other websites. They are like letters of recommendation for your site. Since this factor is crucial to SEO, you should have a strategy to improve the quantity and quality of backlinks.
Sample—No Backlinks Found.!!

Related Websites—

This lists the websites related to your domain. Some may be competitors while others may be websites with related content.
Sample—A list of comparable websites

Discoverability—Technology:

Doctype—

A document type declaration, or DOCTYPE, defines which version of (X)HTML your webpage is actually using and this is essential to a proper rendering and functioning of web documents in compliant browsers.
Sample—Version:
XHTML 1.0 Strict

Image File Format—

The best way to improve image speeds is to reduce file size and the easiest way to reduce file size is to use an image format that is optimized for the web: JPG, PNG, GIF
Sample—Great!! You're not using heavy file formats

Encoding—

Specifying language/character encoding can prevent problems with the rendering of special characters.
Sample—Great, language/character encoding is specified.
UTF-8

Web Server—

A Web server is a program that uses HTTP (Hypertext Transfer Protocol) to serve the files that form Web pages to users, in response to their requests, which are forwarded by their computers' HTTP clients. Leading Web servers include Apache (the most widely-installed Web server), Microsoft's Internet Information Server (IIS) and nginx (pronounced engine X) from NGNIX. Other Web servers include Novell's NetWare server, Google Web Server (GWS) and IBM's family of Domino servers
Sample—Microsoft-IIS/8.0

Name Server—

Nameserver is a server on the internet specialized in handling queries regarding the location of a domain name's various services. Nameservers are a fundamental part of the Domain Name System (DNS). They allow using domains instead ofiP addresses.
Sample—Name Server(s):
NS1.NETMAGICIANS.COM, NS2.NETMAGICIANS.COM,

Server IP—

Your server comes with a dedicated IP address you can use to access your server.
Sample—‘Server IP’ found to be null!

Site Elements—

The Site Elements that we are considering are CSS, Gzip Compression, Cookies, Etag, SPDY, IPV6, HTTP/2, HTTP Strict Transport Security & Frameset.

| Site Elements | Presence |
|---|---|
| CSS | [symbol] |
| Cookies | [symbol] |
| Etag | [symbol] |
| Frameset | [symbol] |
| Gzip Compression | [symbol] |
| HTTP Strict transport Security | [symbol] |
| HTTP/2 | [symbol] |
| IPV6 | [symbol] |
| SPDY | [symbol] |

### G) Advantages of the Invention

The present method allows a consumer oriented data acquisition and analytics in a short time span thus easing a client to optimize their digital platform and enhance the consumer experience.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A method of accumulating a consumer experience related data over a targeted digital platform comprising the steps of:
integrating a computer readable code with a target digital platform for collecting data pertaining to the digital platform, wherein the collected data comprises a working of the digital platform;
categorizing the working of the digital platform and a consumer reaction towards the digital platform into a plurality of primary parameters;
sub-categorizing the plurality of primary parameters into a plurality of secondary parameters, wherein each secondary parameter represents a working aspect of the corresponding primary parameter;
accumulating a data for digital platform function and consumer behaviour against the secondary parameters;
wherein, the computer readable code observes the primary and secondary parameters during a run time usage of a target digital platform by a user, wherein the computer readable code maps the accumulated data against the secondary parameters with the parameters of an optimally running digital platform taken as reference.

2. The method according to claim 1, wherein the computer readable code autocorrects the secondary parameters to attain the parameters of the optimally digital platform taken as reference.

3. The method according to claim 1, wherein the computer readable code provides specific suggestion on the basis of analysis of the secondary parameters for improving a function of digital platform and a consumer experience.

4. The method according to claim 1, wherein the primary parameters comprise discoverability, accessibility, performance, omni-channel and perception.

5. The method according to claim 4, wherein the secondary parameters under discoverability comprise visitors, mobility, search engine optimization, technology, usability, security, social share-ability, and speed optimization.

6. The method according to claim 4, wherein the secondary parameters under accessibility comprises perceivable, operable, understandable and robust.

7. The method according to claim 4, wherein the secondary parameters under performance comprise minification, response time, page size, stability, investigate, measure and validate other quality attributes.

8. The method according to claim 4, wherein the secondary parameters under omni-channel comprise windows layout, MAC layout, workflow, device flow, orientation, redirect & link and touch & scroll.

9. The method according to claim 4, wherein the secondary parameters under perception comprise thinking, patience and visual appeal.

10. The method according to claim 1, wherein the primary and secondary parameters are relative in nature, wherein a value of the secondary parameters is calculated on a basis of a reference parameter obtained from a near-perfect digital platform.

11. The method according to claim 1, wherein the primary and secondary parameters are absolute in nature, wherein a value of the secondary parameters is calculated on a basis of an estimated maximum value of considered parameter, wherein the estimated maximum value is provided through a mathematical based formula.
